(19) United States
(12) Patent Application Publication
(10) Pub. No.: US 2023/0282411 A1
(43) Pub. Date: Sep. 7, 2023

(54) Primary Coil and a Method for Manufacturing a Primary Coil

(71) Applicant: ABB Schweiz AG, Baden (CH)

(72) Inventors: Jedrzej Banaszczyk, Wieliczka (PL); Adam Anszczak, Przasnysz (PL); Wojciech Piasecki, Krakow (PL); Wojciech Wysocki, Krakow (PL); Bartlomiej Adamczyk, Sieniawa (PL)

(73) Assignee: ABB Schweiz AG, Baden (CH)

(21) Appl. No.: 18/181,673

(22) Filed: Mar. 10, 2023

Related U.S. Application Data
(63) Continuation of application No. PCT/IB2021/058237, filed on Sep. 10, 2021.

(30) Foreign Application Priority Data
Sep. 11, 2020 (EP) 20195646.3

(51) Int. Cl. H01F 27/32; H01F 41/12; H01F 27/28

(52) U.S. Cl. CPC H01F 27/327; H01F 41/122; H01F 27/323; H01F 27/288; H01F 2027/329

(57) ABSTRACT

A primary coil suitable for use in a transformer includes a primary winding bobbin onto which a layer of a primary winding and at least one layer, which includes a fixed number of 1 to 3 layers, of an interlayer insulation material are wound alternately, wherein the interlayer insulation material and the primary winding are impregnated with an epoxy, and wherein the interlayer insulation material is a nonwoven material or a crepe paper.

### CROSS-REFERENCE TO RELATED APPLICATIONS

This patent application claims priority to International Patent Application No. PCT/IB2021/058237, filed on Sep. 10, 2021, and to European Patent Application No. 20195646.3, filed on Sep. 11, 2010, each of which is incorporated herein in its entirety by reference.

### FIELD OF THE DISCLOSURE

The present invention disclosure to a primary coil suitable to use in a transformer and a method for manufacturing a primary coil suitable to use in a transformer.

### BACKGROUND OF THE INVENTION

State of the art medium voltage transformers are cast in epoxy, typically filled with silica or alumina fillers. The winding of the transformer comprises inter-layer insulating foil of a polymeric material, or a combination of polymer and paper. The epoxy with mineral fillers cannot fully penetrate the interlayer insulation, which often leads to partial discharges.

In state-of-the-art epoxy cast dry medium voltage transformers sheets of PET (Mylar, DPF or TVT) act the interlayer support material for the primary winding. The winding is then placed in a mold, together with the core and cast in silica filled epoxy resin through the APG (Automatic Pressure Gelation) process. The silica helps reduce the thermal shrinkage and mechanical stress in the epoxy, and it also improves the epoxy thermal conductivity. However, the viscosity of silica filled epoxy is too high for it to fully penetrate between the layers of the primary winding. In fact, silica filled epoxy penetrates only the outer edges of the insulating material sheets, until it reaches the edges of the winding layer, as it is shown in FIG. 1, in which cross section of a dry medium voltage transformer primary winding—silica filled epoxy resin PA1 only penetrates the outer edges PA3 of the DPF PA2 used as inter-layer insulation.

This solution can give rise to high partial discharges activity, detected during routine tests, which may potentially disqualify the complete unit at the end of the production process, resulting in a relatively high production scrap rate and scrap cost. Having the resin penetrate the winding completely is of definite advantage, as it reduces the risk of failing the routine tests and prolongs the service time of the medium voltage apparatus, owing to significantly reduced partial discharges activity.

Document RU2107350C1 relates to electrical engineering and to high voltage transformers with cast epoxy insulation. According to the disclosure a cast transformer comprising a molded insulating casing with a magnetic circuit, high voltage and low voltage windings, with low and high voltage shields, characterized in that it has an external molded insulating housing, a common grounded shield, a high voltage input located inside a common grounded shield located in the cast insulating casing, a second grounded shield made of a semiconducting material located on the outer surface of the cast insulating casing, congruent to the latter and having height 0.6-0.7 of the height of the transformer is disclosed.

Document CN104992829A relates to a production process for a low-partial-discharge long-service-lifetime semi-enclosed casting type voltage transformer. The production process comprises painting, winding of secondary coils, insulation, winding of primary coils, binding, testing, mold filing, drying, casting of mixture ingredients, casting, curing, mold removing, painting, and assembling. According to the production process of the low-partial-discharge long-service-lifetime semi-enclosed casting type voltage transformer, a step type temperature curing process is employed in a curing process of the casted mixture, the curing degree of a casting body is improved, the casted mixture is cured more fully, the possibility of cracks in the product is reduced, the yield of the manufactured voltage transformer is increased, the insulation strength of the casting body is greatly improved, the partial discharge quantity of the voltage transformer can reach the national standard <=20PC, the service lifetime of the whole voltage transformer is greatly extended, and the safety performance of the voltage transformer is enhanced.

Document CN204927013U relates to a novel pouring type voltage transformer that includes an insulating device. Specifically, an insulating skeleton with epoxy and silicon powder mixture is poured into a mold and replaces a traditional primary winding skeleton.

Document EP2075806A1 discloses a dry-type resin-insulated transformer comprising at least one primary winding and one secondary winding arranged coaxially with each other, with the secondary internal to the primary, the windings being jointly encapsulated in a body of insulating resin having the shape of a cylindrical annulus, wherein the outer cylindrical surface of the resin body is covered with a first metal shield in the form of a split cylinder, electrically grounded and formed of a metal mesh incorporated in the resin of the insulating body and stiffened by upper and lower inwardly folded rims and two outwardly folded axial juxtaposed edges, whereas a second grounded shield is formed of a metal mesh wrapped around the outer cylindrical surface of the secondary winding.

### BRIEF SUMMARY OF THE INVENTION

The embodiments in accordance with the present disclosure provide significant enhancements in the performance and reliability of medium voltage transformers, reduce partial discharge activity on both the interior and exterior of that apparatus, while additionally enhancing the safety of operation by introduction of a touch proof feature of the transformer surface. The disclosure renders possible simultaneous reduction of the scrap cost and scrap rate with respect to state-of-the-art medium voltage transformers.

The present disclosure describes a new concept medium voltage transformer, based on PET nonwoven interlayer insulation, impregnated with low viscosity epoxy, with an additional grounded screen embedded within the epoxy-cast structure of the winding. The winding of the transformer, comprising the additional insulation layer and a grounded screen is cast in epoxy without the core. As the external surface of the pre-cast winding is at the ground potential, the electric field between the winding and the grounded core is eliminated. Additionally, the embedded grounded screen adds the touch proof feature for enhanced safety of operation when a shielded cable termination is used to at the HV terminal. Several concept demos of the medium voltage transformer with embedded grounded screen successfully passed the 1 min. AC power frequency test, as well as the partial discharges tests and the LI test, which confirms the technical feasibility of the epoxy impregnated PET nonwoven-based solution.

In the embodiments of the present disclosure, a solution is presented where the PET interlayer winding support material is replaced with impregnable PET nonwoven. In addition, several layers of the same nonwoven material are wound on top of the HV coil providing sufficient thickness of the insulating distance to the ground. Finally, a grounded screen is fashioned on the winding structure, which screen is made of semiconductive crepe paper that is nonwoven, or of another impregnable conductive material.

The entire coil structure with the external grounded (GND) screen can be impregnated void free with low viscosity impregnation resin, which eliminates the issue of PD in medium voltage transformers. Furthermore, owing to the external GND screen, all electrical field is confined within the cast, rendering the unit touch proof, and making it possible to decrease the core dimensions, as no insulation is required between the cast and the core. The modular design of the transformer makes it possible to test each primary coil module separately, before assembly of the whole transformer unit. This very significantly reduces the scrap cost of the apparatus.

### BRIEF DESCRIPTION OF THE SEVERAL VIEWS OF THE DRAWING(S)

FIG. 1 is a coil in accordance with the prior art.

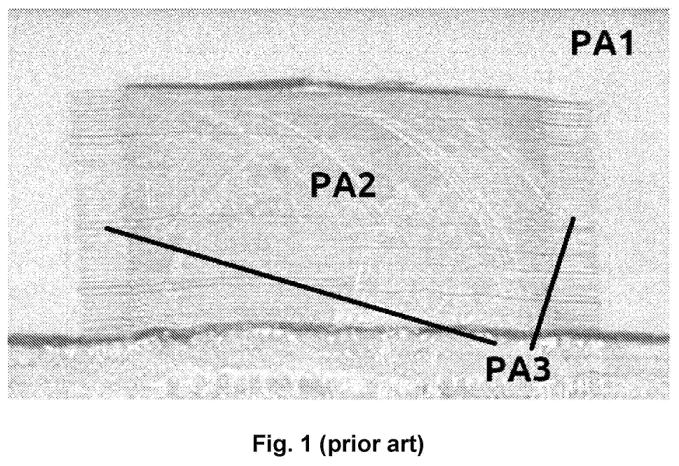

FIG. 2 is a schematic cross section of a transformer comprising a primary coil according to the present disclosure. In this illustration, a schematic structure of the primary coil is also visible.

FIG. 3 is an illustration of a prototype of a transformer according to the present disclosure.

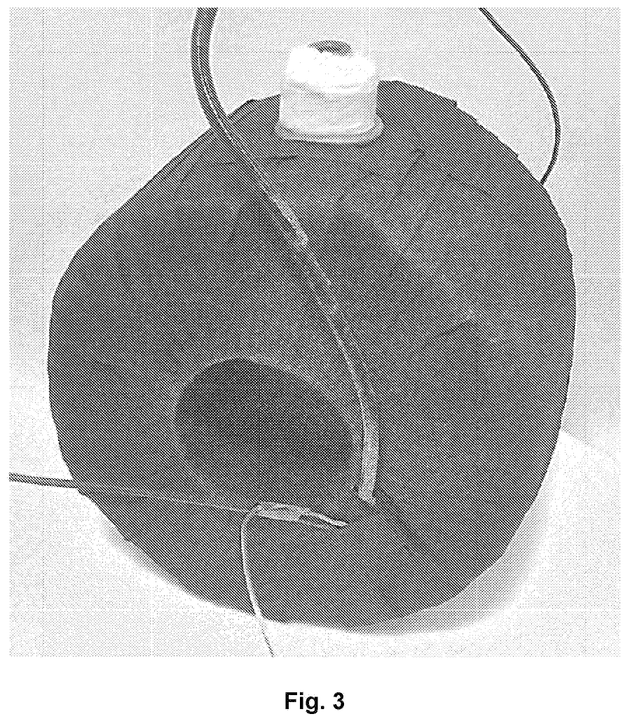

FIG. 4 illustrates a structure of the primary coil obtained with a method according to the present disclosure.

In the figures, the following reference numerals are used:
1—field grading ring;
2—high voltage screen;
3—grounding screen;
4—primary winding bobbin;
5—primary winding;
6—secondary winding bobbin;
7—secondary winding;
8—epoxy cast;
9—housing;
10—pad-mount;
11—epoxy.

### DETAILED DESCRIPTION OF THE INVENTION

According to the embodiment of the present disclosure, a primary coil, in the form of an epoxy cast 8, suitable to use in a transformer, is presented. The primary coil comprises a primary winding bobbin 4 on which a layer of a primary winding 5 and at least one layer, preferably a fixed number of 1 to 3 layers of an interlayer insulation material are wound alternately. A primary winding bobbin 4 allows to wind the primary winding 5 on it, so the primary winding 5 have some rigid bases to be placed on. The interlayer insulation provides higher protection to partial discharges. The interlayer insulation material is a nonwoven material or a crepe paper. Furthermore, the interlayer insulation material and the primary winding 5 are impregnated with an epoxy 11, which further improves protection to partial discharges and makes the primary coil more durable. This solution also eliminates voids, which are present in coils known in the art.

Preferably, the interlayer insulation material is a nonwoven fabric made of polyethylene terephthalate, PET. Presented materials provide sufficient protection to partial discharges and may be impregnated with the epoxy 11.

In another embodiment, the primary coil comprises at least one layer of the interlayer insulation material and a high voltage screen 2 over the most external layer of the primary winding 5. There is at least one layer of the interlayer insulation material and a grounding screen 3 on top of the high voltage screen 2. This solution provides greater electrical protection. The embedded grounding screen 3 adds the touch proof feature for enhanced safety of operation. In this embodiment, a transformer housing is not necessary to provide sufficient electrical protection.

In yet another embodiment, the high voltage screen 2 is made of a semiconducting paper sheet or semiconducting paper tape, or a semiconducting nonwoven sheet or a semiconducting nonwoven tape, or a semiconducting foam. This enables to provide a solution which is easy to manufacture with typical equipment used for winding coils.

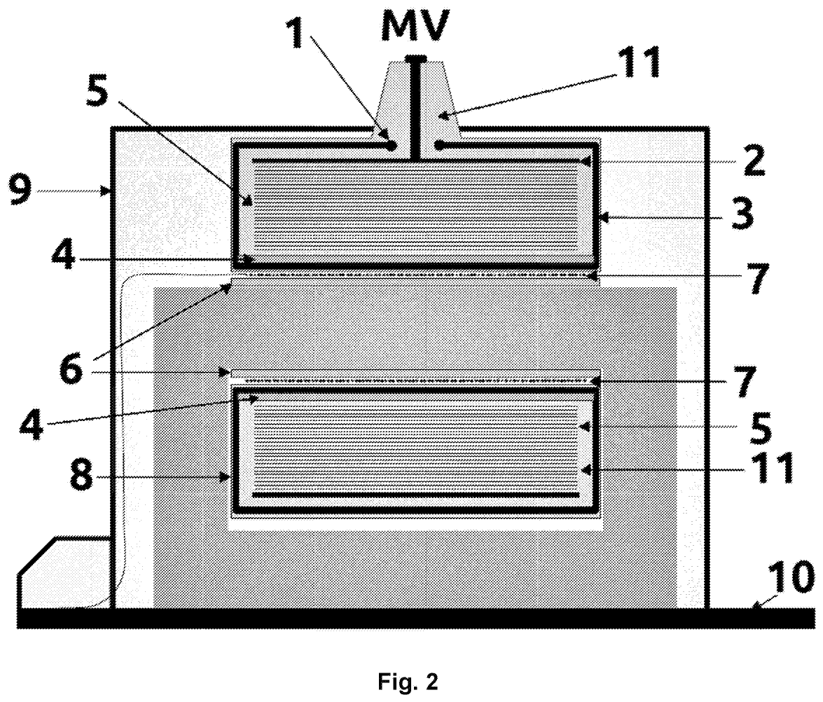

In another embodiment, a transformer comprising a core, a primary winding 5 and a secondary winding 7 is described, wherein the primary winding 5 is in the form of the primary coil as described in any of the previous embodiments. Such transformer, during testing, provides less waste during production. In case of any failures, each part of the transformer may be replaced. In transformers known from the prior art, a whole transformer is impregnated with an epoxy. In such case, replacement is not possible and the whole transformer must be replaced. Furthermore, the primary coil, as described above, allows to use the transformer without a housing, which makes the transformer cheaper, lighter and easier to manufacture and store. FIG. 2 presents the transformer according to this embodiment.

In yet another embodiment, for enhanced explosion safety and/or for a touch proof solution with enhanced safety, the transformer may comprise a housing 9, wherein the housing 9 may be made of dielectric material and/or any other material that is grounded.

According to another embodiment, a method for manufacturing a primary coil suitable to use in a transformer is presented. The method comprising the steps of:
a) winding at least one of layer of an interlayer insulation material onto the primary winding bobbin 4,
b) winding alternately a layer of a primary winding (5) and at least one layer of the interlayer insulation material, preferably 1 to 3 layers of the interlayer insulation material,
c) winding, after last layer of the primary winding 5 has been wound, a small number of layers of the interlayer insulation material on top of the primary winding,
d) fitting the this obtained primary coil into a mold,
e) drying the primary coil,
f) impregnating the primary coil with a low viscosity epoxy 11 by filling the mold with the low viscosity epoxy 11,
g) curing of the low viscosity epoxy 11,
h) taking the primary coil out of the mold, wherein the interlayer insulation material is a nonwoven material, preferably a nonwoven fabric made of polyethylene terephthalate, PET, or the interlayer insulation material is a crepe paper. A final product is the primary coil in form of an epoxy cast 8.

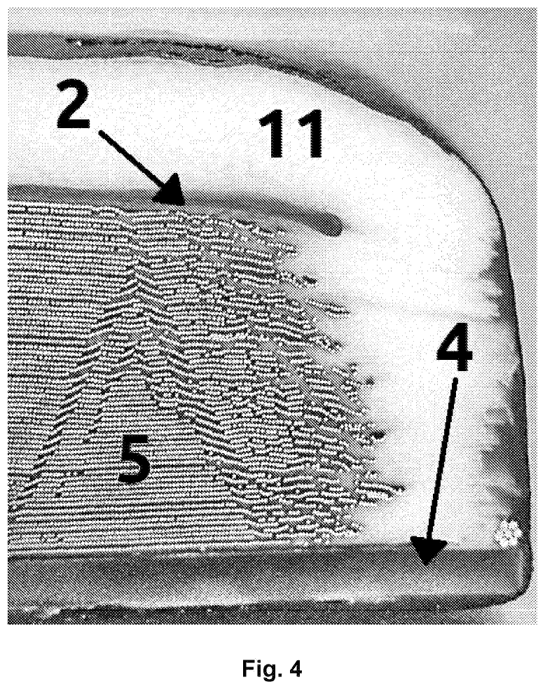

As it can be seen in FIG. 4, the method according to the invention provides better impregnation of the primary coil with the epoxy 11. As a result of performing the method, there are no voids between the primary winding 5 and the epoxy 11 provides improved protection against partial discharges and makes the primary coil more durable due to a greater contact surface.

In another embodiment, the method comprises a step of cyclically altering a pressure between 1 mbar and 1 bar once the mold is filled with the low viscosity epoxy 11. This allows to remove all air bubbles in epoxy (11), which may result in voids within the primary coil.

In yet another embodiment, the step of drying is performed for an one hour, preferably at 60° C., and even more preferably, in a vacuum. This allows to slowly cure epoxy 11 within a mold. This process allows to further increase the protection against partial discharges by providing epoxy 11 with suitable parameters after curing.

In another embodiment, after the last winding layer has been wound and before the step of fitting the primary coil into the mold, a step of winding at least one layer of the interlayer insulation material is wound on top, after that a step of winding a high voltage screen 2 is performed. Preferably the high voltage screen 2 is made of a semiconducting paper tape, after that a step of winding of at least one layer of the interlayer insulation material is performed on top of the high voltage screen 2, and after that a step of winding of a grounded screen is performed 3.

In yet another embodiment the interlayer insulation material is heat welded during winding, preferably at about 220° C. This provides easier manufacturing process during winding.

The invention has numerous advantages and benefits, which include:
Increased lifetime and reliability of dry MV VT apparatus;
Touch proof solution with significant enhancement of operation safety owing to a GND external screen embedded in the cast;
Environmentally friendly solution;
easy recovery of secondary raw materials;
Potential for additional explosion protection with a grounded metal housing, which can be filled with, e.g., sand, for maximum safety;
Reduced delivery time owing to the modular design of the VT;
Enhanced product performance at same production cost;
Reduced scrap rate—much smaller PD probability due to better impregnation process;
Reduced scrap cost—in case of unsuccessful failed tests only the primary coil, and not the whole VT unit is scrapped;
No additional processing of the cast required;
Reduced material and labor cost—elimination of core padding;
Possible to adjust the metering class with a correction coil—scrap rate reduction;
Reduced delivery time owing to an off-the-shelf modular design;
Reduced product line maintenance and downtime; and others.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A primary coil suitable to use in a transformer, comprising:
a primary winding bobbin on which a layer of a primary winding and at least one layer of a fixed number of 1 to 3 layers of an interlayer insulation material are wound alternately;
wherein the interlayer insulation material and the primary winding are impregnated with an epoxy; and
wherein the interlayer insulation material is a nonwoven material or a crepe paper.

2. The primary coil according to claim 1, wherein the interlayer insulation material is a nonwoven fabric made of polyethylene terephthalate, PET.

3. The primary coil according to claim 1, further comprising at least one layer of the interlayer insulation material and a high voltage screen disposed over an external layer of the primary winding, wherein at least one layer of the interlayer insulation material and a grounding screen are disposed over the high voltage screen.

4. The primary coil according to claim 3, wherein the high voltage screen is made of a semiconducting paper sheet or semiconducting paper tape, or a semiconducting nonwoven sheet or a semiconducting nonwoven tape, or a semiconducting foam.

5. A transformer, comprising:
a core;
a primary winding; and
a secondary winding;
wherein the primary winding is a primary coil, the primary coil comprising:
a primary winding bobbin on which a layer of a primary winding and at least one layer of a fixed number of 1 to 3 layers of an interlayer insulation material are wound alternately;
wherein the interlayer insulation material and the primary winding are impregnated with an epoxy; and
wherein the interlayer insulation material is a nonwoven material or a crepe paper.

6. The transformer according to claim 5, further comprising a housing, the housing being made of dielectric material and/or being grounded.

7. A method for manufacturing a primary coil suitable to use in a transformer, the method comprising:
a) winding at least one of layer of an interlayer insulation material onto a primary winding bobbin;
b) winding alternately a layer of a primary winding and at least one layer of the interlayer insulation material, wherein the interlayer insulation material winding is repeated 1 to 3 times;
c) winding, after a last layer of the primary winding has been wound, a number of layers of the interlayer insulation material on top of the primary winding to obtain a primary coil;
d) fitting the primary coil into a mold;
e) drying the primary coil;
f) impregnating the primary coil with a low viscosity epoxy by filling the mold with the low viscosity epoxy;
g) curing of the low viscosity epoxy; and
h) removing the primary coil from the mold;
wherein the interlayer insulation material is a nonwoven material.

8. The method of claim 7, wherein the nonwoven material is one of a nonwoven fabric made of polyethylene terephthalate, PET, or a crepe paper.

9. The method according to claim 7, wherein once the mold is filled with the low viscosity epoxy, an internal pressure of the mold is cyclically altered between 1 mbar and 1 bar.

10. The method according to claim 7, wherein drying is performed for one hour at 60° C. and in a vacuum.

11. The method according to claim 7, wherein after the last winding layer has been wound and before the step of fitting the primary coil into the mold, a step of winding at least one layer of the interlayer insulation material is wound on top, after that a step of winding a high voltage screen is performed, wherein preferably the high voltage screen is made of a semiconducting paper tape, after that a step of winding of at least one layer of the interlayer insulation material is performed on top of the high voltage screen, and after that a step of winding of a grounded screen is performed.

12. The method according to claim 7, wherein the interlayer insulation material is heat welded during winding at a temperature of about 220° C.
